(19) United States
(12) Patent Application Publication
(10) Pub. No.: US 2015/0169061 A1
(43) Pub. Date: Jun. 18, 2015

(54) Information Terminal Processor and Vibration Generator

(71) Applicant: NIDEC COPAL CORPORATION, Tokyo (JP)

(72) Inventors: Shin ODAJIMA, Tokyo (JP); Yuki SHODA, Tokyo (JP); Masaaki TAKAGI, Tokyo (JP); Yoshihide TONOGAI, Tokyo (JP)

(73) Assignee: NIDEC COPAL CORPORATION, Tokyo (JP)

(21) Appl. No.: 14/501,693

(22) Filed: Sep. 30, 2014

(30) Foreign Application Priority Data
Sep. 30, 2013 (JP) 2013-204257

(51) Int. Cl. G06F 3/01; G06F 3/041; G06F 1/16; H02K 33/16

(52) U.S. Cl. CPC G06F 3/016; H02K 33/16; G06F 3/041; G06F 1/169

(57) ABSTRACT

An information terminal processing device includes a casing with a touch panel that houses a circuit board, a touch panel, a vibration actuator having a movable element for reciprocating movement and a housing to house the movable element that forces the movable element to strike the housing corresponding to an operation for the touch panel, and a vibration transmitting part interposed between the vibration actuator and the touch panel and that reduces the frequency of the vibration generated at the vibration actuator and transmits the vibration to the touch panel.

### CROSS-REFERENCE TO RELATED APPLICATION

This application claims priority under 35 U.S.C. §119 to Japanese Patent Application No. 2013-204257, filed on Sep. 30, 2013, the entire content of which being hereby incorporated herein by reference.

### TECHNICAL FIELD OF THE INVENTION

The present invention relates to an information terminal processing device that improves the operational feel by generating vibration corresponding to the sensor panel operation, as well as a vibration generator utilized in the information terminal processing device.

### BACKGROUND

A touch panel, which is an example of a sensor panel, is a product that performs the input operation of information by touching an image or the like displayed on a panel, and can be operated intuitively. However, since there is no operational sense like that felt when pressing a physical button, for example, it is difficult to sense whether or not the input operation has been performed normally. Therefore, for example, there is a device to give the operator an operational feel by generating vibration corresponding to the input operation.

For the technology in this field, Publication of Unexamined Patent Application No. 2001-347227 (“the JP '227”), for example, describes a vibrator employed in a wireless communication terminal such as a cellular telephone and the like. This vibrator generates vibration by having a vibrating element strike a spot material.

However, the vibrator in the JP '227 is mounted directly to the sensor panel, and if the vibration generated by the vibrator is utilized as the feedback for the sensor panel operation, since the frequency of the vibration to the sensor panel can become high, there have been times when it was difficult to be perceived by the operator, and the operational feel was poor.

Accordingly, an aspect of the present invention is to provide an information terminal processing device capable of improving the operational feel with the sensor panel operation, as well as a vibration generator utilized in the information terminal processing device.

### SUMMARY

The present invention is an information terminal processing device characterized by the fact that a casing with a sensor panel houses a circuit board, comprising a vibrating part that is at least the casing or the circuit board, a vibration actuator having a movable element for reciprocating movement and a housing to house the movable element that forces the movable element to strike the housing corresponding to an operation for the sensor panel, and a vibration transmitting part interposed between the vibration actuator and the vibrating part, that reduces the frequency of the vibration generated at the vibration actuator and transmits the vibration to the vibrating part.

The information terminal processing device according to the present invention generates vibration by means of the movable element striking the housing, so it is possible to create a highly responsive vibration for operation of the sensor panel. Additionally, in the information terminal processing device according to the present invention, since there is a vibration transmitting part interposed between the vibration actuator and the vibrating part, the frequency of the vibration generated by the impact is reduced and the vibration is transmitted to the vibrating part. Furthermore, the information terminal processing device according to the present invention makes it possible to provide highly responsive vibration to the vibrating part that is easy for the operator to perceive, which makes it possible to improve the operational feel corresponding to operation of the sensor panel.

Additionally, the vibration actuator further comprises a coil disposed inside the housing so as to surround the magnet configured of the movable element, and a weight disposed between the coil and the housing. With this configuration, since the mass of the vibration actuator increases, the resonance frequency for the vibration system comprising the vibration actuator and the vibration transmitting part becomes lower. However, since the frequency of the vibration generated by the impact becomes lower, it is possible to further improve the operational feel so the operator can easily perceive the vibration.

Also, the movable element has a cylindrical magnet and yokes mounted on both end faces in the vibration direction of the magnet, and the vibration actuator further comprises a shock absorbing part mounted on the housing facing each of the yokes and the vibration direction. With this configuration, since the movable element has a magnet and yokes, the mass of the movable element becomes larger compared to when the movable element is a coil. Since the momentum of the movable element becomes larger when the mass of the movable element is large, it is possible for a larger impact force to be created. Therefore, it is possible to create a greater vibration that can be reliably sensed by the operator. Also, since the yokes of the movable element collide with the shock absorbing part mounted on the housing, it is possible to protect the magnet from the impact, and it is possible to reduce the noise of the impact generated from the impact with the shock absorbing part.

The present invention is characterized by the fact that a vibration generator is built into an information terminal processing device, comprising a movable element for reciprocating movement, a housing to house the movable element and that the movable element strikes by movement corresponding to an operation for the information terminal processing device, and a vibration transmitting part provided on the outside of the housing that reduces the frequency of the vibration generated according to the impact of the movable element and transmits the vibration.

The information terminal processing device according to the present invention generates vibration by the movable element striking the housing, so it is possible to create a highly responsive vibration.

Also, with the vibration generator according to the present invention, since the vibration transmitting part is provided on the outside of the housing, the frequency of the vibration generated by the impact is reduced for transmission. Furthermore, the vibration generator according to the present invention makes it possible to generate highly responsive vibration that is easy for the operator to perceive, which makes it possible to improve the operational feel.

With the information terminal processing device and vibration generator according to the present invention, it is possible to improve the operational feel of operation by a sensor panel.

### BRIEF DESCRIPTION OF THE DRAWINGS

FIG. 1 is an external perspective drawing showing Example of the information terminal processing device pertaining to the present invention.

FIG. 2 is a cross-section perspective drawing showing the vibration actuator of the information terminal processing device shown in FIG. 1.

FIG. 3 is a cross-section drawing of the vibration actuator along line in FIG. 2.

FIG. 4 is a cross-section drawing showing the operation of the vibration actuator along line IV-IV in FIG. 3.

FIG. 5 is a graph showing the waveform of the drive pulse signals and the vibration waveform transmitted to the touch panel.

FIG. 6 is a cross-section drawing showing Another Example of the information terminal processing device pertaining to the present invention.

FIG. 7 is a cross-section drawing showing a variation of the information terminal processing device pertaining to the present invention.

### DETAILED DESCRIPTION

Next are detailed descriptions of examples for the information terminal processing device and vibration generator pertaining to the present invention, with reference to the drawings.

### EXAMPLE

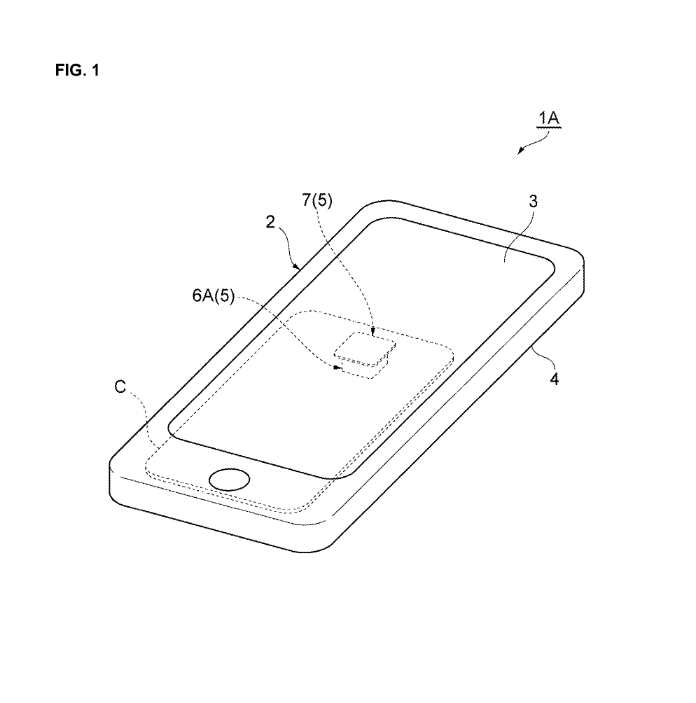

As shown in FIG. 1, the information terminal processing device 1A is an information terminal for a smart phone or the like. The information terminal processing device 1A houses a casing (vibrating part) 2 that accommodates a circuit board C and a battery and such. The casing 2 has a touch panel 3 as the sensor panel for information display and information input, and a frame 4 of a strong material that surrounds the information terminal processing device 1A. This information terminal processing device 1A is equipped with a vibration generator 5 mounted on the side opposing the side with the display screen for the touch panel 3. This vibration generator 5 is equipped with a vibration actuator 6A as the vibration generation source and a vibration transmitting part 7 to transmit the generated vibration to the touch panel 3. This vibration generator 5 generates vibration to make the operator aware that a normal input operation has been performed when the operator touches the touch panel 3 with a finger to perform an operation.

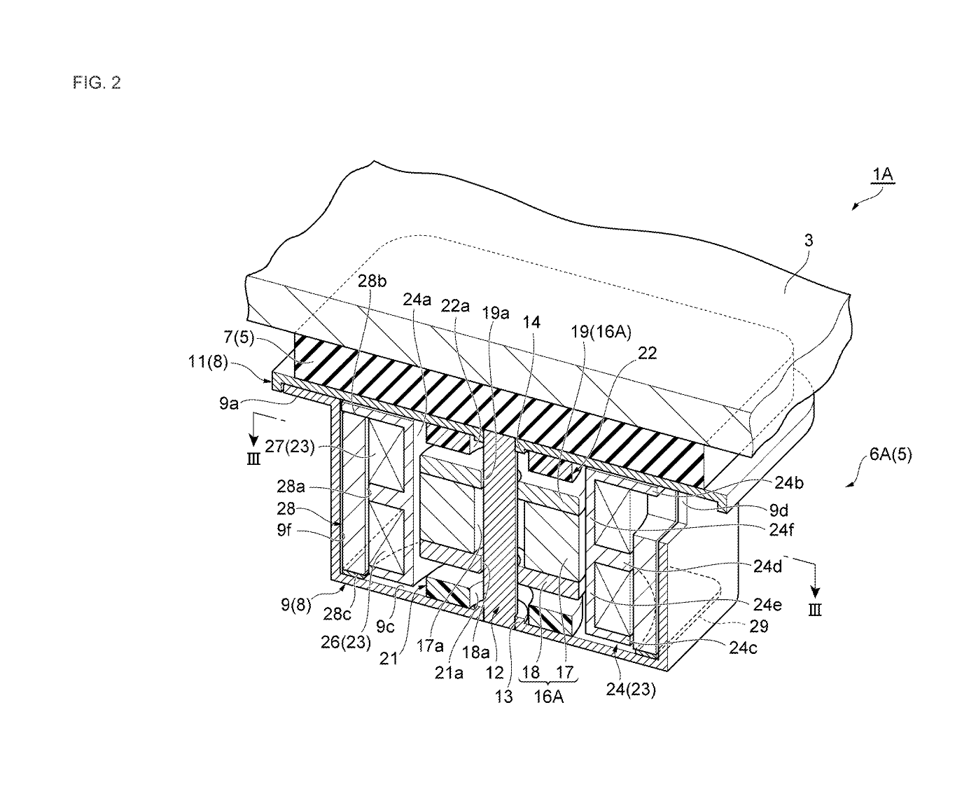

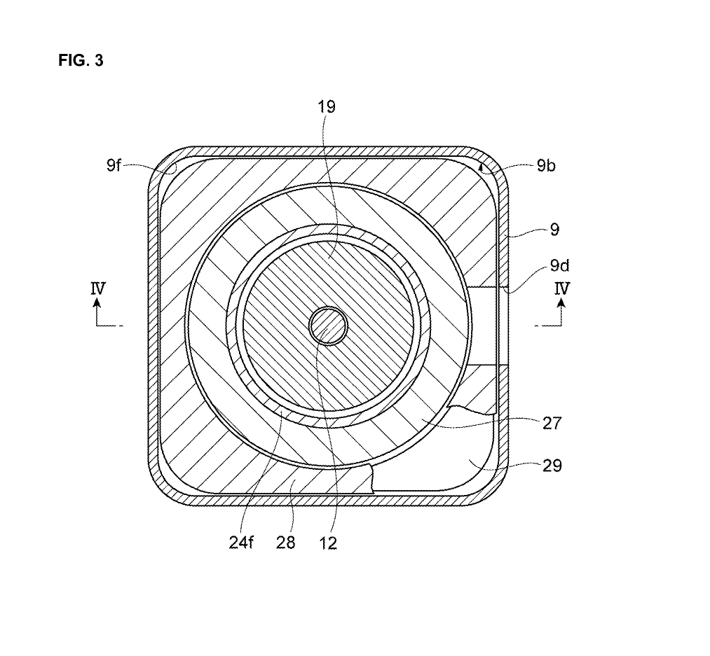

As shown in FIG. 2 and FIG. 3, the housing 8 for the vibration actuator 6A has a body case part 9 that is a roughly rectangular cuboid shaped case and a cover part 11 to lock the open side of the body case part 9. This body case part 9 and cover part 11 are of stainless steel so the material is not magnetic. A flange part 9a is provided on the open side of the body case part 9, and the cover part 11 covers the opening 9b (refer to FIG. 3) and the flange part 9a so as to lock the opening 9b securely to the body case part 9.

A guide shaft 12 is disposed in roughly the center of the housing 8. The guide shaft 12 is disposed so the axial direction extends in the direction from the cover part 11 to the base 9c of the body case part 9. The lower end of the guide shaft 12 is fitted into the indentation opening 13 provided on the base 9c of the body case part 9, and the top end is fitted into the indentation opening 14 provided on the cover part 11.

The vibration actuator 6A has a moving magnet linear vibration actuator configuration.

The movable element 16A is disposed inside the housing 8 enclosing the guide shaft 12 for reciprocating movement along the axial direction of the guide shaft 12.

The movable element 16A has a monopole magnetized magnet 17 having a north pole and a south pole in the axial direction of the guide shaft 12, and a through-hole 17 is provided on this magnet 17 that extends in the axial direction, where the guide shaft 12 is inserted. Additionally, the movable element 16A has a first yoke 18 fastened to the lower end face of the magnet 17 and a second yoke 19 fastened to the upper end face of the magnet 17. The thin disc shaped first and second yokes 18, 19 are secured to interpose the magnet 17 in the axial direction of the guide shaft 12 so as to cover the entirety of both end faces of the magnet 17. Also, there are guide holes 18a, 19a formed on the first and second yokes 18, 19 to guide the movable element 16A in the axial direction of the guide shaft 12 in conjunction with the guide shaft 12. Therefore, the vibration direction of the movable element 16A for linear reciprocating movement matches the axial direction of the guide shaft 12.

There is a cushion (shock absorbing part) 21 attached on the base 9c of the body case part 9 in a position opposing the axial direction of the first yoke 18 and the guide shaft 12. Also, there is a cushion (shock absorbing part) 22 attached on the cover part 11 in a position opposing the axial direction of the second yoke 19 and the guide shaft 12. The shape of each of these cushions 21, 22 is ring-shaped with holes 21a, 22a where the guide shaft 12 is inserted.

A stator 23 is disposed inside the housing 8 surrounding the movable element 16A. The stator 23 has a bobbin 24. The bobbin 24 has an opening 24a that extends in the axial direction of the guide shaft 12, an upper flange part 24b provided on the side of the cover part 11, a lower flange part 24c provided on the side of the base 9c, and a partitioning part 24d provided between the upper flange part 24b and the lower flange part 24c. A first bobbin part 24e is formed between the lower flange part 24c and the partitioning part 24d, and a second bobbin part 24f is formed between the upper flange part 24b and the partitioning part 24d. These first and second bobbin parts 24e, 24f are provided parallel to the axial direction of the guide shaft 12.

Additionally, the stator 23 has two coil parts 26, 27 with a serial connection. The first coil part 26 is formed so the coil wire is wound around the first bobbin part 24e to correspond with the first yoke 18. The second coil part 27 is formed so the coil wire is wound around the second bobbin part 24f to correspond with the second yoke 19. These first and second coil parts 26, 27 are provided parallel to the axial direction of the guide shaft 12. The winding directions of the coil wires are mutually opposite, and the ends of the coil wires are drawn out from the outlet 9d provided on the side of the body case part 9 to the outside of the housing 8.

A weight 28 is arranged inside the housing so as to be embedded in the space between the first and second coil parts 26, 27 and the body case part 9. The upper flange part 24b of the bobbin 24 comes into contact with the upper end face 28b of the weight 28 in the axial direction of the guide shaft 12, and the weight 28 is secured by being pressed into the side of the base 9c of the body case part 9 with the upper flange part 24b. The weight 28 that has a point symmetrical shape with the axis of the guide shaft 12 has an opening 28a that is round and where the bobbin 24 and the first and second coil parts 26, 27 can be inserted, and the center of gravity of the weight 28 is arranged inside the housing 8 so as to be positioned on the axis of the guide shaft 12. The weight 28 is made of a material with a relatively high density (such as tungsten).

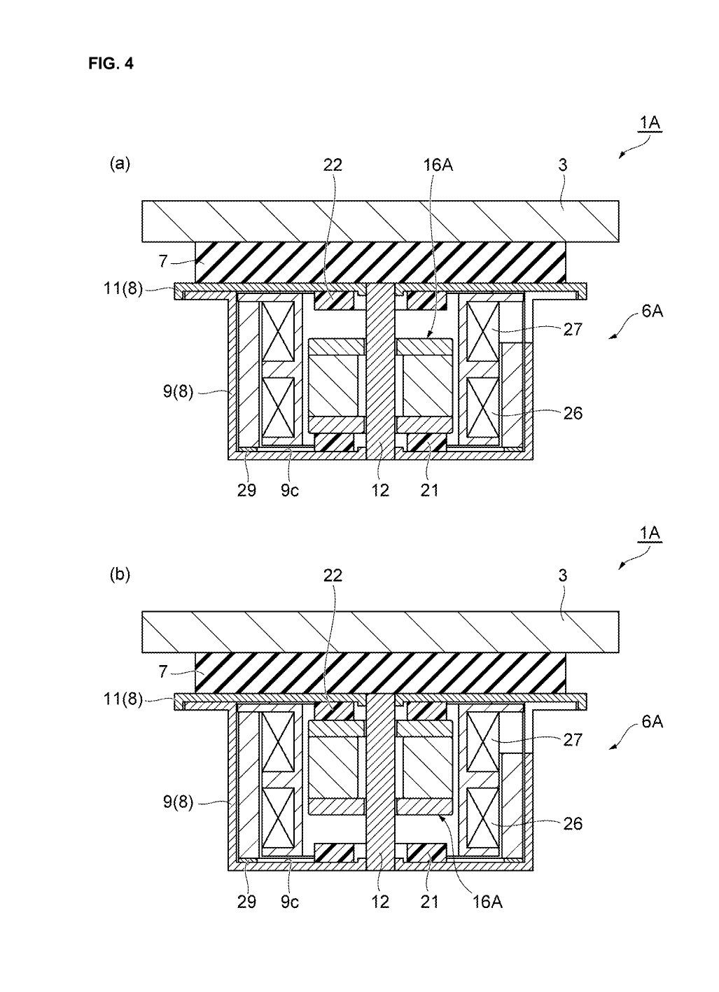

There is a magnetic plate 29 interposed between the base 9c of the body case part 9 and the lower end face 28c of the weight 28 in the axial direction of the guide shaft 12. The magnetic plate 29 is a rectangular steel plate, and has a similar planar shape as the weight 28. The magnetic plate 29 works with the magnet 17, and the movable element 16A gravitates towards the side of the base 9c when the first and second coil parts 26, 27 are not energized (refer to FIG. 4(a)). With the magnetic plate 29, since it is possible to set the position of the movable element 16A to the side of the base 9c when not energized, it is possible to reliably drive the movable element 16A in the direction of the cover part 11 by inputting drive pulse signals. Also, generation of the sound of the impact from unintentional movement of the movable element 16A when not energized can be prevented.

The vibration transmitting part 7 consisting of an elastic member is interposed between the vibration actuator 6A and the touch panel 3. The vibration transmitting part 7 is fastened to the vibration actuator 6A and the touch panel 3. By decreasing the vibration frequency generated with the vibration actuator 6A to the frequency band of 150 Hz˜500 Hz that is easy for the operator to perceive, this vibration transmitting part 7 is something that changes the vibration waveform from a shock waveform with a sharp peak to a vibration waveform that is close to a sine wave vibration for transmission to the touch panel 3. In particular, a rubber material with a density of 0.3˜1.0 g/cm³ is optimal for this vibration transmitting part 7.

Next is a description of the operation of the information terminal processing device 1A. In the state where the operator does not touch the touch panel 3, a drive pulse signal is not input to the first and second coil parts 26, 27, and so is a state that is not energized. In this case, as shown in FIG. 4(a), the movable element 16A gravitates towards the side of the base 9c of the body case part 9 by the magnetic plate 29.

When the operator touches the touch panel 3 and determines that the data input has been properly executed, the controller (not shown in the drawings) inputs the drive pulse signal to the first and second coil parts 26, 27. This drive pulse signal is set to a frequency close to the resonance frequency (about several hundred Hz) of the touch panel 3, and the direction of the current is set to the direction that the movable element 16A moves towards the side of the cover part 11.

As shown in FIG. 4(b), if the drive pulse signal is input to the first and second coil parts 26, 27, the movable element 16A follows the axial direction of the guide shaft 12 in the direction of the cover part 11 and strikes the cushion 22 of the cover part 11. With this impact, the entire vibration actuator 6A moves along the axial direction and generates a vibration wave, and the vibration wave is transmitted to the touch panel 3 by the vibration transmitting part 7. If the operator perceives the vibration wave transmitted to this touch panel 3, the operator senses the operational feel.

Since the vibration actuator 6A of the information terminal processing device 1A generates vibration by the movable element 16A striking the housing 8, it is possible to create a highly responsive vibration for operation of the touch panel 3. Additionally, since the vibration transmitting part 7 is interposed between the vibration actuator 6A and the touch panel 3, the information terminal processing device 1A reduces the frequency of the vibration generated by this impact and this vibration is transmitted to the touch panel 3. Therefore, since it is possible for the information terminal processing device 1A to provide the touch panel 3 with highly responsive vibration that is easy for the operator to perceive, tactile feedback that is responsive and easy to sense is realized, which makes it possible to improve the operational feel corresponding to operation of the touch panel 3.

Furthermore, the vibration actuator 6A has first and second coil parts 26, 27 disposed inside the housing 8 so as to enclose the magnet 17 comprising the movable element 16A and a weight 28 disposed between the first and second coil parts 26, 27 and the housing 8. With this configuration, since the mass of the vibration actuator 6A increases, the resonance frequency for the vibration system comprising the vibration actuator 6A and the vibration transmitting part 7 becomes lower. Therefore, since the frequency of the vibration generated by the impact becomes lower, it is possible to further improve the operational feel so the operator can easily sense the vibration.

Also, since the vibration actuator 6A has a moving magnet configuration where the movable element 16A has a magnet 17 and a first and second yoke 18, 19, the mass of the movable element 16A becomes larger when compared to the moving coil configuration where the movable element 16A has first and second coil parts 26, 27. If the mass of the movable element 16A is large, since the momentum of the movable element 16A becomes greater, it is possible for a larger impact force to be created. Therefore, it is possible to create a greater vibration that can be reliably perceived by the operator.

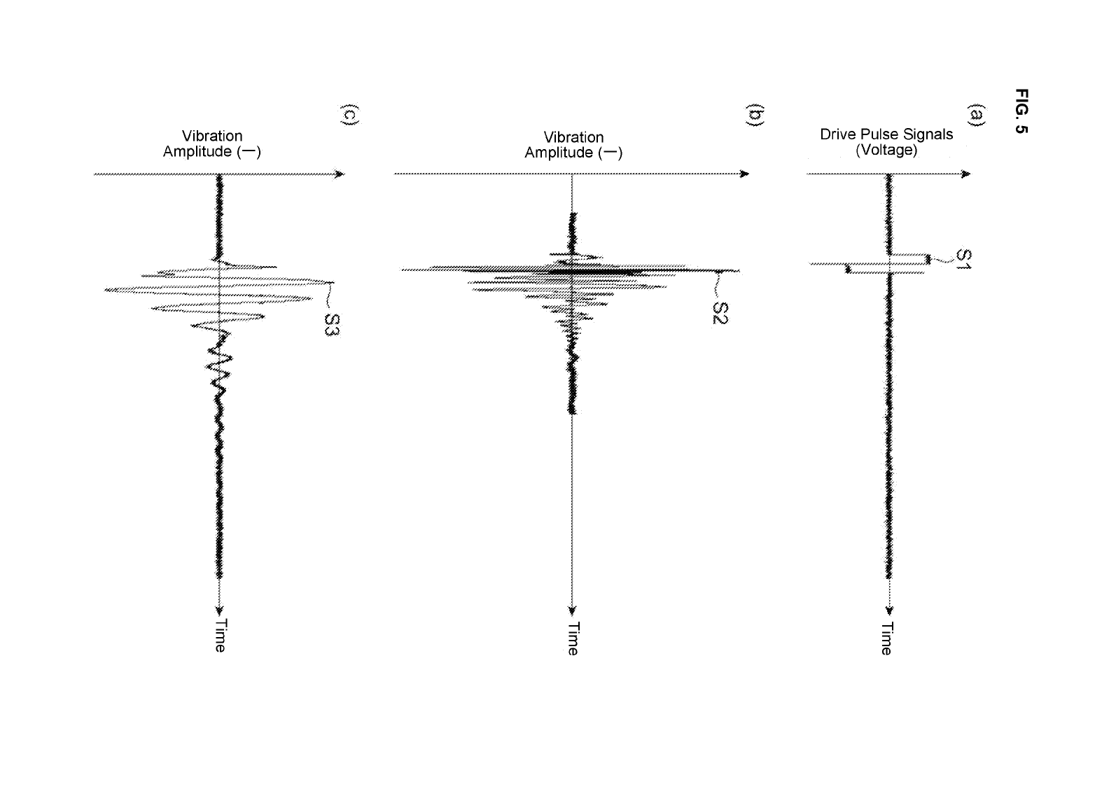

Here, to verify the effect of the information terminal processing device 1A, the information terminal processing device 1A and an information terminal processing device with a vibration actuator not having a weight 28 mounted directly to the touch panel 3 as a comparative example were manufactured, and the waveform of each of the vibrations transmitted to the touch panel 3 were verified. Drive pulse signals were input to the information terminal processing device 1A and information terminal processing device involved in the comparative example that had the same amplitude and the same frequency. To be more specific, as shown in FIG. 5(a), the drive pulse signal S1 is a signal with a cycle that has a frequency of 440 Hz.

As shown in FIG. 5(b), it was confirmed that the vibration waveform S2 transmitted to the touch panel 3 by the information terminal processing device in the comparative example had a high frequency with a sharp peak.

On the other hand, as shown in FIG. 5(b), in the case where a vibration actuator 6A having a weight 28 was mounted to the touch panel 3 with the vibration transmitting part 7, it was confirmed that the frequency was lower that than of the vibration waveform A2 from the comparative example, and the vibration waveform S3 was close to a sine wave vibration. Furthermore, with the information terminal processing device 1A where the mass was increased by positioning the weight 28 on the vibration actuator 6A and by mounting the vibration actuator 6A on the touch panel 3 with the vibration transmitting part 7, it can be understood that vibration that is easy for the operator to perceive can be generated.

Additionally, since the first and second yoke 18, 19 of the movable element 16A strike the cushion 22 mounted on the housing 8, it is possible to protect the magnet 17 from the impact. Also, it is possible to reduce the noise of the impact generated from the impact with the cushion 22.

Additionally, with the information terminal processing device 1A, since the movable element 16A generates vibration by striking the cushion 22, when comparing the vibration actuator with an eccentric weight mounted on the rotary motor (Comparative Example 1) with a vibration actuator using spring resonance (Comparative Example 2), since the vibration start and stop time is short, it is possible to increase the sense of use through tactile feedback. Also, while it is possible to increase the response speed with a vibration actuator employing a piezo-electric element (Comparative Example 3), the piezo-electric element is larger in order to get a vibration amplitude that the operator can perceive. In contrast to this, the information terminal processing device 1A in this example can be smaller than the vibration actuator using a piezo-electric element (Comparative Example 3).

Also, the vibration amplitude of the touch panel 3 can be increased by setting the frequency of the drive pulse signal close to the resonance frequency of the touch panel 3.

### Another Example

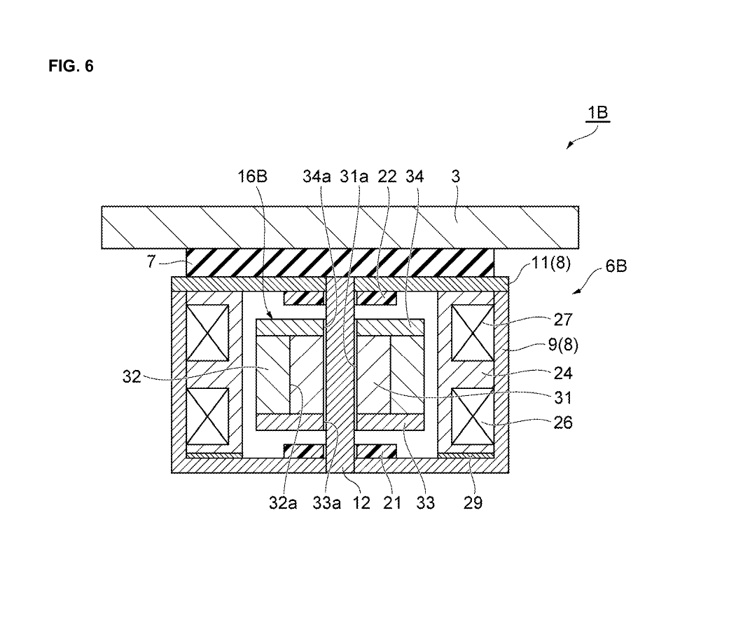

The information terminal processing device in the Another Example is described. As shown in FIG. 6, the information terminal processing device 1B differs from the information terminal processing device 1A in the Example in that the weight 31 on the vibration actuator 6B is provided on the movable element 16B. Next is a detailed explanation of the weight 31, where the description of the elements common to the information terminal processing device 1A in the Example is omitted.

The weight 31 having a cylindrical shape is unitized with a magnet 32 embedded in the through-hole 32a provided on the magnet 32. Also, a guide shaft 12 is inserted in the through-hole 31a provided in roughly the center of the weight 31. A first yoke 33 provided with a guide hole 33a is fastened at the lower end face of the weight 31 and magnet 32 in the axial direction of the guide shaft 12 while a second yoke 34 provided with a guide hole 34a is fastened at the lower end face of the weight 31 and magnet 32.

Since the mass of the movable element 16B is greater with this vibration actuator 6B, it is possible to increase the amount of movement of the movable element 16B. Since the amplitude of the vibration waveform created when the movable element 16B strikes the cushion 21 or the cushion 22 increases as the amount of movement of the movable element 16B increases, it is possible to create a large enough vibration that the operator can reliably sense.

The present invention is not limited to the examples described above, and the following variations are acceptable as long as they do not depart from the scope of the present invention.

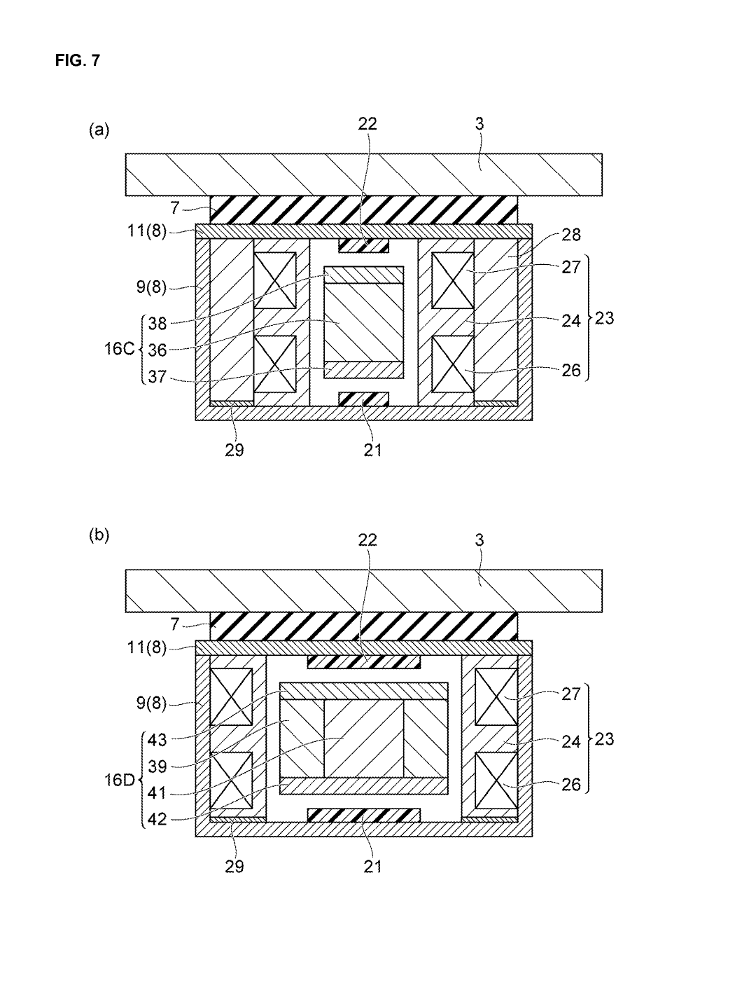

As shown in FIG. 7(a), the vibration actuator 6A in the Example is not furnished with a guide shaft 12 but it can be furnished with a movable element 16C instead of the movable element 16A. The movable element 16C has yokes 37, 38 mounted on both end faces of the magnet 36 shaped like a column. With this configuration, since there is no contact between the guide holes 18a, 19a (refer to FIG. 2) of the movable element 16A and the guide shaft 12, it is possible to increase the amount of movement from the movable element 16A to increase the speed of movement of the movable element 16A.

Additionally, as shown in FIG. 7(b), the vibration actuator 6B in the Another Example is also not furnished with a guide shaft 12 but it can be furnished with a movable element 16D instead of the movable element 16B. With the movable element 16D, there is a weight 41 embedded inside the cylindrical magnet 39, with yokes 42, 43 mounted on both end faces of the magnet 39 and weight 41. Even with this configuration, since there is no contact between the guide holes 33a, 34a (refer to FIG. 6) of the movable element 16B and the guide shaft 12, it is possible to increase the amount of movement from the movable element 16B to increase the speed of movement of the movable element 16B.

Additionally, the movable element 16A, 16B moves from the side of the base 9c of the housing 8 to the side of the cover part 11, and after colliding with the cushion 22 of the cover part 11, it drives to the side of the base 9c and can strike the cushion 21 on the base 9c. Also, there is reciprocating movement of the movable element 16A, 16B between the cushion 21 and the cushion 22, so impact may be generated multiple times.

Also, the vibration actuator 6A, 6B may be furnished with a guide tube (not shown in the drawings) instead of a guide shaft 12 to accommodate the movable element 16A, 16B for guiding in the vibration direction.

Additionally, the vibration actuator 6A, 6B may be mounted on the frame 4 forming the casing 2 of the information terminal processing device 1A, 1B, or mounted on the circuit board C disposed inside the casing 2.

Furthermore, the number of coils for the vibration actuator 6A, 6B is not limited to two, and one is acceptable, as is more than two. Additionally, the vibration actuator 6A, 6B cushion 21, 22 can be fastened to the top of the second yoke 19, 33 and the bottom of the first yoke 18, 34.

Also, the position of the movable element 16A, 16B when not energized is not limited to the side of the base 9c of the housing 8, and can be on the side of the cover part 11 according to the mounting posture and vibration direction of the vibration actuator 6A, 6B. In this case, the magnetic plate 29 is situated to be interposed between the upper flange part 24b of the bobbin 24 and the cover part 11.

Also, the information terminal processing device 1A, 1B is not limited to cell phones or smart phones, and can be employed in devices such as vending machines, automated ticket machines, personal computers, information kiosks and other such devices equipped with a touch panel 3.

Furthermore, the description in this example was for a sensor panel that is a panel touched directly but the sensor panel can be, for example, a panel that is operated from close proximity. Also, the sensor panel can use a pen type input means or can be a panel operated by touch or from close proximity. Further, multiple vibration patterns can be produced by disposing a plurality of vibration actuators 6A, 6B on the device.

### Further Examples

The following is a description of the materials that are preferred for use as the elastic member utilized in the vibration transmitting part 7.

In the present invention, preferred materials for the vibration transmitting part 7 include styrene gel (KG gel manufactured by Kitagawa Industries Co., Ltd., model number: YMG90V, density: 1.29 g/cm³), silicone gel (silicone film manufactured by Taica Corporation, model number: θ-7, density: 1.06 g/cm³), urethane foam (manufactured by Inoac Corporation, model number: SR-S15P, density: 0.15 g/cm³) and the like. With a vibration transmitting part 7 of these materials, it is possible to reduce the frequency of vibration transmitted to the touch panel 3 more than when the vibration actuator 6A is mounted directly to the touch panel 3.

In the present invention, more preferred materials for the vibration transmitting part 7 are natural rubber (density 0.93 g/cm³), styrene gel (KG gel manufactured by Kitagawa Industries Co., Ltd., model number: YMG80BK, density: 0.87 g/cm³), urethane foam (manufactured by Inoac Corporation, model number: WP932P, density: 0.32 g/cm³, model number: WP-40P, density: 0.40 g/cm³, model number: SR-S48P, density: 0.48 g/cm³) and such. With a vibration transmitting part 7 of these materials, it is possible to reduce the frequency of vibration transmitted to the touch panel 3 more than when the vibration actuator 6A is mounted directly to the touch panel 3. Furthermore, it is possible to maintain the vibration amplitude appropriate for the operator to perceive by controlling the decrease in the amplitude of the vibration,

On the other hand, an ethyl polyurethane (manufactured by Sanshin Enterprises, Co. Ltd., model number: SORBO S, density: 1.38 g/cm³, manufactured by Sanshin Enterprises, Co. Ltd., model number: SORBO M, density: 1.38 g/cm³) increases the vibration frequency transmitted to the touch panel in the same manner as when the vibration actuator 6A is directly mounted to the touch panel 3 and so is not appropriate.

1. An information terminal processing device comprising:
a casing with a sensor panel that houses a circuit board;
a vibrating part that is at least one of said casing and said circuit board;
a vibration actuator having a movable element for reciprocating movement and a housing to house said movable element that forces said movable element to strike said housing corresponding to an operation for said sensor panel; and
a vibration transmitting part interposed between said vibration actuator and said vibrating part, that reduces the frequency of the vibration generated at said vibration actuator and transmits said vibration to said vibrating part.

2. The information terminal processing device according to claim 1, wherein
said vibration actuator further comprises
a coil disposed inside said housing so as to surround the magnet configured of said movable element, and
a weight disposed between said coil and said housing.

3. The information terminal processing device according to claim 1, wherein
said movable element further comprises
a cylindrical magnet and yokes mounted on both end faces in the vibration direction of said magnet, and
said vibration actuator further comprises
a shock absorbing part mounted on said housing facing each of said yokes and said vibration direction.

4. A vibration generator built into an information terminal processing device, the vibration generator comprising:
a movable element for reciprocating movement;
a housing to house said movable element and that said movable element strikes by movement corresponding to an operation for said information terminal processing device; and
a vibration transmitting part provided on the outside of said housing that reduces the frequency of the vibration generated according to the impact of said movable element and transmits the vibration.
